(19) United States
(12) Patent Application Publication
(10) Pub. No.: US 2008/0014565 A1
(43) Pub. Date: Jan. 17, 2008

(54) INTERACTIVE COMMUNICATION DEVICE AND METHOD OF USE THEREOF

(76) Inventor: Gabrielle RAUMBERGER, Hermosa Beach, CA (US)

Correspondence Address: HAHN LOESER & PARKS, LLP, One GOJO Plaza, Suite 300, AKRON, OH, 44311-1076, US

(21) Appl. No.: 11/768,714

(22) Filed: Jun. 26, 2007

Related U.S. Application Data
(60) Provisional application No. 60/805,825, filed on Jun. 26, 2006.

(51) Int. Cl. G09B 19/00

(52) U.S. Cl. 434/236

(57) ABSTRACT

The present invention relates to an interactive device and method of using the device for initiating communication between players to discuss the player's emotions. The device utilizes tokens of various colors, each color depicting an emotion. As the players interact with each other during their regular daily activities, the players select a token of a color representing an emotion evoked by the players' mutual interaction. At the end of a period, the players take turns evaluating their collected tokens and discussing their emotions based on the emotions corresponding to their collected tokens.

This applications claims priority from provisional application Ser. No. 60/805,825, filed Jun. 26, 2006. Application Ser. No. 60/805,825 is hereby incorporated by reference.

### BACKGROUND AND SUMMARY OF THE DISCLOSURE

This invention relates to an interactive device used to initiate communication between people.

The concept of emotion is complex, and there is no single universally accepted definition of “emotion.” Emotions are spontaneous mental states that do not arise through conscious effort. Some consider emotion to be the antithesis of reason. Emotions can be undesired by the individual feeling them, as he or she may wish to control emotions but often cannot. Thus one of the distinctive and challenging attributes of human beings is this potential for entanglement, or even opposition, between will, emotion, and reason.

Emotion is different from feeling, in that emotion is a psycho-physiological state that moves an organism to action. Feeling, on the other hand, is emotion that filters through the cognitive brain centers, such as the frontal lobe, producing a physiological change in addition to the psycho-physiological change.

As emotions and feelings can sometimes seem uncontrollable, humans continuously strive to control them. The study of emotions is part of psychology, neuroscience, and, more recently, artificial intelligence. One teaching of modern psychology is that whether or not they realize it, humans choose how they want to feel. This teaching is highlighted in modern techniques for dealing with interpersonal relationships, including the use of “I” statements, such as “I felt angry,” instead of “you” statements, such as “you made me angry.”

For therapeutic purposes, as well as entertainment purposes, people have long enjoyed and benefited from the use of games in assisting them to better their interpersonal communications skills. Games used to promote communication and the expression of emotions and feelings may be beneficial as they allow for increased understanding of the affect of feelings and behaviors upon oneself and others. Such games may allow a players to make a connection between feelings, behaviors, and consequences, and help people to feel accepted and understood.

Interactive activities designed to improve communication between people are disclosed in U.S. Pat. No. 6,422,558 to Chambers and U.S. Pat. No. 4,966,371 to Sherman.

While the prior art improves communication between people in relationships, there remains a need in the art for an improved interactive activity that overcomes these and other disadvantages of the prior art.

The present invention overcomes at least one of these disadvantages by providing an interactive communication device comprising a plurality of tokens comprising at least a first color and a second color, a first container having one or more compartments sized to contain a multiplicity of tokens and a second container having one or more compartments sized to contain a multiplicity of tokens.

The present invention further overcomes at least one of these disadvantages by providing a method of using an interactive communication device comprising the steps of (a) providing to each player a container having one or more compartments sized to contain a multiplicity of tokens, (b) providing to each player a plurality of tokens having a first color to represent a positive emotion, (c) providing to each player a plurality of tokens having a second color to represent a negative emotion, (d) having a first interaction between the players evoking at least one positive or negative emotion in at least one player, (e) selecting, by the emotive player, a token having the first color if the emotion was positive or a token having the second color if the emotion was negative, (f) collecting, by the emotive player, the selected token in one of the one or more compartments of the container, (g) repeating steps (d)-(f) for an extended time, (h) revealing to each player the tokens collected in the player's compartment, and (i) discussing the emotions represented by each player's collected tokens.

The device may induce each player to express and communicate emotions to the other players. Two players may play or an unlimited number of players may participate.

These and other features of the invention are more fully described below and particularly pointed out in the claims, the following detailed description setting forth certain illustrative embodiments of the invention and indicating but a few of the various ways in which the principles of the present invention may be employed.

### BRIEF DESCRIPTION OF THE DRAWINGS

FIG. 1 is a perspective view of a container of the present disclosure; and

FIG. 2 is a perspective view of an alternate container and lid of the present disclosure.

### DETAILED DESCRIPTION OF THE DRAWINGS

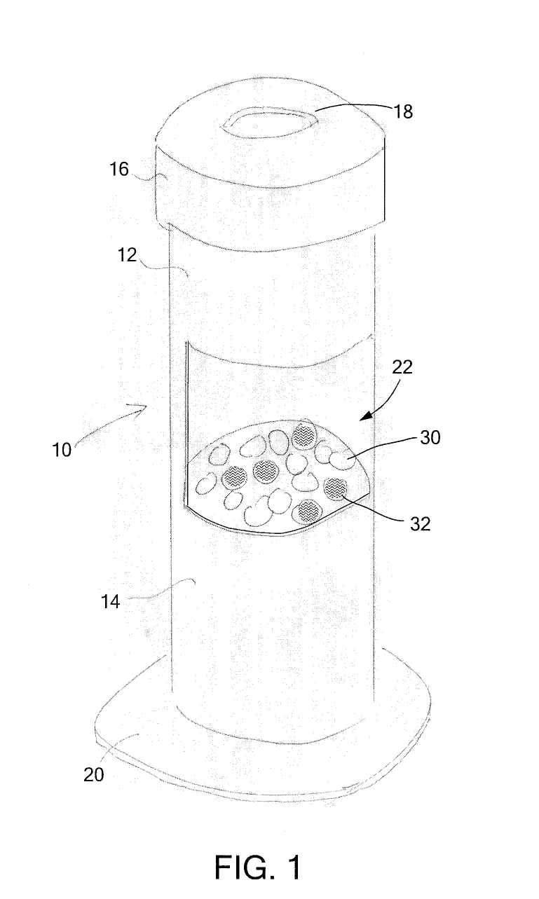

The activity device of the present disclosure may be a game used as a tool to facilitate interactive communication. The activity may be played by at least two players. Referring to FIG. 1, a first embodiment of the device presently disclosed comprises at least one container 10. Each container 10 comprises a first compartment 12 and a second compartment 14. A lid 16 having an aperture 18 may cover the first compartment 12. The container 10 may further comprise a base 20 to improve the stability of the container 10.

The container 10 of FIG. 1 may include the first compartment 12 and the second compartment 14 positioned in a vertical arrangement, with the first compartment 12 at the top. It is contemplated that the container 10 may employ various other arrangements of the first and second compartments. As one example, the compartments may be arranged side by side.

The device includes a plurality of tokens 30, 32 which are separated into a first portion comprising positive tokens 30 and a second portion comprising negative tokens 32. The positive tokens 30 may be employed to represent a first emotion and the negative tokens 32 may be employed to represent a second emotion. The aperture 18 is sized to allow tokens 30, 32 to pass through the lid 16 into the first compartment 12. The first compartment 12 and the second compartment 14 are sized to hold a multiplicity of tokens 30, 32. The second compartment 14 has an opening 22, through which a player can remove tokens.

Containers 10 may be provided for two or more players, where each player has one container 10. The activity is effective when two players play, and the activity may be effectively played with more than two players participating. As at least two players participate in the activity, each player interacts with at least one other player.

The positive tokens 30 may comprise a color representing a positive emotion. The negative tokens 32 may comprise a color representing a negative emotion. For example, the positive tokens 30 may be red to represent affection or admiration, and the negative tokens 32 may be black to represent anger or frustration.

The positive tokens 30 may include tokens of three different colors. Red positive tokens may represent emotions of affection, love, connection, and devotion. Yellow positive tokens may represent emotions of happiness, joy, delight, and pleasure. White positive tokens may represent emotions of harmony, agreement, unity, and meeting of minds or hearts. In addition to comprising different colors, each positive token 30 may also be labeled with a first message comprising at least a first word indicating the emotion represented by the color of the token 30.

The negative tokens 32 may include tokens of three different colors. Green negative tokens may represent emotions of betrayal, insincerity, dishonesty, or jealousy. Blue negative tokens may represent emotions of sadness, heavy heart, or melancholy. Black negative tokens may represent emotions of anger, frustration, and feeling mad. In addition to comprising different colors, each negative token 32 may also be labeled with a second message comprising at least a second word indicating the emotion represented by the color of the token 32.

Alternatively, the activity device may employ tokens 30, 32 that do not have a specific color. However, the tokens 30, 32 may be labeled with a message. The first portion of the tokens 30 may be labeled with a first message and the second portion of the tokens 32 may be labeled with a second message. The first message may comprise at least one first word, while the second message may comprise at least one second word. Additionally, the color of each message may represent an emotion, which is likewise depicted by the wording of the text. For example, the message may be a word printed on the token, such as “sad.” In another example, the word “sad” may be printed in a blue color, further identifying the emotion.

The activity may employ fewer token colors or additional token colors to change the depth and complexity of the communication between the players.

The activity device may also employ tokens 30, 32 that do not include labels of specific emotions. The players may use the colored tokens to reflect any emotions that they are feeling at the time. This arrangement may permit players to discuss emotions that are not specifically categorized by labels.

To start the activity, the players each select one container 10 and a multiplicity of tokens 30, 32. Each player places their tokens in the second compartment 14 at the beginning of the activity.

Alternately, the container 10 has only one compartment. In this embodiment, each player stores tokens 30, 32 in a separate container 10. Alternately, a source of tokens 30, 32 may be stored in a shared receptacle.

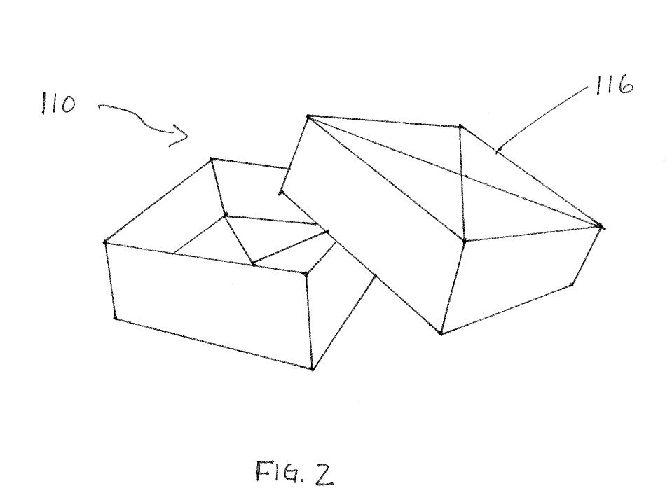

In yet a further alternate, the container 10 may formed from at least one sheet of paper or similar foldable material. During the initial setup, each player engages in constructing at least one container 10 for storing tokens 30, 32 using origami-style paper folding techniques. The relative complexity of the techniques used in creating the container 10 may be varied depending on the players' interests. For example, using origami techniques a container may be assembled from a single sheet of paper, or a more complex container 110 may be created using multiple sheets of paper as shown in FIG. 2. The container 110 may include a lid 116.

In an additional alternate, the activity may be played without a container. All of the tokens 30, 32 are initially placed in a first group which functions as a source of tokens to both players. Further, each player designates a location to serve as a collection point of that player's group of individually collected tokens. For example, a player may choose to designate a spot on the player's dresser or nightstand to accumulate the players' collection of selected tokens. Throughout the duration of the activity, each player may transfer tokens 30, 32 from the first group to that player's designated token collection point, depending on the emotions evoked in that player. By designating a specific location, each player is able to maintain a collection of tokens in an easy to remember location, reducing the risk of losing or misplacing the player's collected tokens.

The activity continues as the players continue their day-to-day activities. When each player interacts with another player during their everyday activities, the interaction between the players may evoke a positive or negative emotion in at least one of the players. If a player experiences an emotion from the interaction, the emotive player selects one of the positive tokens 30 if the emotion was positive or a negative token 32 if the emotion was negative, and places the selected token into the first compartment 12.

The players continue to interact as they go about their regular daily activities for the duration of the activity, selecting positive tokens 30 or negative tokens 32 as their interactions cause emotions and placing the selected tokens 30, 32 into the first compartment 12. The activity may continue for at least three days, for a week, or for another selected duration. At the end of the play, the players meet to discuss their collected tokens.

When the players meet at the end of the duration of the activity, the players select a first player to discuss their emotions first, and a second player to discuss their emotions second. The first player starts by reviewing the tokens that the first player collected in the first compartment 12. The variety of colors selected is indicative of how the first player felt about the players' relationship during the time of play. For example, if the first compartment 12 contained more negative tokens 32 than positive tokens 30, that fact alone may be a source of discussion between the players. After two or three days, the first player may not remember all of the specific events that caused the emotions. That the first player cannot remember the specific event may be advantageous because if the first player cannot remember the event, it is likely that the event was not significant. Players may learn that some things that seem significant at one time may be insignificant in the long term. The general discussion of the player's emotions during the activity often encompasses these insignificant events. Those events that were significant and remembered are a source of separate discussion. The first player's turn continues until the players finish discussing the events and emotions the first player experienced during the activity.

The second player then reveals the tokens that the second player collected, and the discussion continues in the same manner as the first. Additional players subsequently take turns revealing their collected tokens.

The players may focus on the overall pattern of the token colors taken together. For example, when all of a player's collected tokens are the negative tokens 32 such as a black color, the players may discuss this observation and discuss why the player may not be recognizing or experiencing positive emotions. Conversely, if all of a player's collected tokens are the positive tokens 30 such as a red color, the players may discuss this observation and discuss why the player may not be recognizing or experiencing negative emotions.

After each of the players has a turn discussing their collected tokens, the activity ends. Alternately, the players may reset the activity device by removing all of the tokens 30, 32 from the first compartment 12 and resuming the activity with an empty first compartment 12.

The players interact between emotion discussions for a duration of one week. Alternately, the players may discuss their collected tokens after three or four days. While the players may tailor the activity to meet their relationship needs, waiting longer than one week to communicate about their emotions can cause the players to forget events and emotions that the players should discuss. Conversely, having discussions more frequent than three days induces the players to discuss events and emotions that would seem insignificant after a few days pass.

The players meet in person to discuss their emotions. Alternately, the players may talk to each other over the telephone to discuss their emotions. The telephone is useful when the players are a large distance from one another and cannot meet in person. The players discuss their emotions electronically by text messaging, video, electronic mail, or other computerized interaction.

Additional advantages and modifications will readily occur to those skilled in the art. Therefore, the invention in its broader aspects is not limited to the specific details and illustrative examples described here. Accordingly, various modifications may be made without departing from the spirit or scope of the invention as defined by the appended claims and their equivalents.

1. An interactive communication device for play by at least two players comprising:
a plurality of tokens, the plurality of tokens comprising:
a first portion capable of representing a first emotion and
a second portion capable of representing a second emotion, and
a container for each player comprising a first compartment and a second compartment, each compartment capable of holding at least a portion of the plurality of tokens for a player, the second compartment having an opening through which the player can remove tokens and the first compartment having a removable lid and an aperture sized for a token to pass through into the first compartment.

2. The interactive communication device of claim 1, the first compartment and the second compartment being positioned in a vertical arrangement.

3. The interactive communication device of claim 1, the first portion having a first color and the second portion having a second color, the first color representing a positive emotion and the second color representing a negative emotion.

4. The interactive communication device of claim 1, the first portion having a first message comprising at least one first word and the second portion having a second message comprising at least one second word.

5. The interactive communication device of claim 4, the at least one first word representing a positive emotion and the at least one second word representing a negative emotion.

6. The interactive communication game of claim 4, the first message comprising a first color and the second message comprising a second color.

7. The interactive communication device of claim 6, the first color representing a positive emotion and the second color representing a negative emotion.

8. The interactive communication device of claim 1, the first compartment and the second compartment being positioned in a side by side arrangement.

9. The interactive communication device of claim 1, each container constructed from at least one sheet of foldable material by origami-style folding.

10. The method of playing an interactive communication activity with at least one other player comprising the steps of:
(a) obtaining a plurality of tokens, the plurality of tokens comprising:
a first portion capable of representing a first emotion and a second portion capable of representing a second emotion, and
a container for each player comprising a first compartment and a second compartment each compartment capable of holding at least a portion of the plurality of tokens for a player, the second compartment having an opening through which the player can remove tokens, and the first compartment having a removable lid and an aperture sized for a token to pass through into the first compartment;
(b) interacting with at least one other player during regular daily activities for a duration of play;
(c) determining emotions resulting from interactions with at least one other player;
(d) selecting a token from the plurality of tokens in the second compartment corresponding to the determined emotion;
(e) collecting selected tokens during the duration of play in the first compartment;
(f) revealing the collected tokens after termination of the duration of play to the at least one other player; and
(g) discussing the emotions corresponding to the collected tokens with the at least one other player.

11. The method of claim 10, the first portion having a first color and the second portion having a second color.

12. The method of claim 11, further comprising the step of:
selecting a token having the first color if the determined emotion is a positive emotion or selecting a token having the second color if the determined emotion is a negative emotion.

13. The method of claim 10, the first portion having a first message comprising at least one first word and the second portion having a second message comprising at least one second word.

14. The method of claim 13, further comprising the step of:
selecting a token having the first message if the determined emotion is a positive emotion or selecting a token having the second message if the determined emotion is a negative emotion.

15. The method of claim 14, the first message comprising a first color and the second message comprising a second color.

16. The method of claim 15, the first color representing a positive emotion and the second color representing a negative emotion.

17. The method of claim 10, the first compartment and the second compartment being positioned in a vertical arrangement.

18. The method of claim 10, further comprising the step of:
constructing at least one container capable of holding at least a portion of the plurality of tokens from at least one sheet of foldable material by origami-style folding.

19. The method of claim 10, the duration of play lasting one week.

20. The method of claim 10, the duration of play lasting at least three days.
